(19) United States
(12) Patent Application Publication
(10) Pub. No.: US 2024/0099182 A1
(43) Pub. Date: Mar. 28, 2024

(54) SINGLE OPERATOR SEED PLANTING APPARATUSES, SYSTEMS, AND METHODS OF USE

(71) Applicant: Brooklyn Bridge to Cambodia, Inc., Brooklyn, NY (US)

(72) Inventors: Ibrahim FitzGibbon, Solihull, West Midlands (GB); Austin Hultmark, Darien, IL (US); Paula Stocco, Oak Park, IL (US); Tony Morvant, Sangkat Boeng Tumpun, Khan Meanchey (KH)

(21) Appl. No.: 18/276,837

(22) PCT Filed: Feb. 10, 2022
(86) PCT No.: PCT/US2022/016041

§ 371 Date: Aug. 10, 2023

Related U.S. Application Data
(60) Provisional application No. 63/153,821, filed on Feb. 25, 2021.
(60) Provisional application No. 63/148,504, filed on Feb. 11, 2021.

(51) Int. Cl. A01C 7/00; A01C 7/08; A01C 7/20

(52) U.S. Cl. CPC A01C 7/002; A01C 7/082; A01C 7/084; A01C 7/208

(57) ABSTRACT

A seed planting apparatus for planting seeds and performing other agricultural processes includes a chassis, one or more rear wheels coupled to a rear end of the chassis, a seat coupled to the rear end of the chassis, and an air propulsion apparatus and a storage container that are positioned behind the seat. A frame is coupled to the chassis, a plurality of hollow members are coupled to the frame, and a seed metering apparatus is coupled to the plurality of hollow members, arranged so that the seed metering apparatus is in communication with the air propulsion apparatus.

This application claims the benefit of priority under 35 U.S.C. § 119 to U.S. Provisional Application No. 63/148,504 filed 11 Feb. 2021 (11/02/2021), and U.S. Provisional Application No. 63/153,821 filed 25 Feb. 2021 (25/02/2021), the disclosures of which are incorporated by reference herein in their entirety.

### TECHNICAL FIELD

The field of the invention relates to an apparatus and system, and methods of using the apparatus and system, for planting seeds and performing other agricultural processes.

### BACKGROUND

Direct seeding of rice, also known as direct seeding, is an alternative method to the conventional transplanting method of rice seeding. Transplanting is a labor intensive process that involves initially planting seeds, for example, by hand in nursery farms, and then replanting crops at an infant stage into larger fields—either by hand or by using a transplanting machine. “Direct seeding” or “direct sowing” refers to planting seeds directly into the soil of the fields from which the eventual crops will be harvested. Techniques, devices, and systems for direct seeding are disclosed in International Publication No. WO/2020/092576 A1, assigned to the applicant of the instant application, the disclosure of which is hereby incorporated in its entirety herein.

Known techniques for direct seeding may involve utilizing air propulsion to propel seed from a storage container, into a plurality of hollow members, and into the ground. The plurality of hollow members may be substantially evenly spaced along a frame, such that the planted seeds may be substantially evenly spaced across rows. Known techniques for direct seeding may also involve utilizing air propulsion to propel seed from a storage container and into and through a seed metering apparatus, such that the seed is propelled through each of a plurality of attached hollow members sequentially, thereby resulting in a metered stream of seed to each hollow member. Apparatuses, systems, and methods for providing a metered stream of seed are disclosed in International Publication No. WO/2021/155008 and U.S. Provisional Application No. 62/967,389, both assigned to the applicant of the instant application, the disclosures of which are hereby incorporated by reference in their entirety herein.

Existing seed planting apparatuses and seed planting systems are limited in that the turning radius of the seed planting apparatus is limited to the turning radius of the farming vehicle itself. Additionally, the turning radius of existing seed planting apparatuses is limited due to the larger size of existing seed planting apparatuses as compared to those disclosed herein. For example, if a tight turn is attempted, existing seed planting apparatuses may impact the attached farming vehicle or the wheels of existing seed planting apparatuses may skid along a plane parallel to their axis. As a result, existing seed planting apparatuses and seed planting systems may be cumbersome to operate and maneuver in the field. Additionally, because the farming vehicle requires a dedicated driver, existing seed planting apparatuses and seed planting systems often require more than one operator.

In conventional two-wheel tractors, the center of gravity position of the tractor may be positioned at or around the wheel axle of the front wheels of the tractor. In operation, this may result in a dangerous operating condition when the tractor is put into reverse. Specifically, the torque applied to the wheel axles to put the tractor into reverse may be resisted by friction and rotational inertia, causing a reaction torque back on the tractor about the wheel axle. If the center of gravity is positioned at, around, or in front of, the wheel axle of the front wheels of the tractor, the force of gravity acts in the same direction of the torque, thereby contributing to the tractor rotating about the wheel axle and spinning and/or flipping the tractor forward and raising the handles upward. This may result in the operator likewise being raised off of the ground, flipped, or put in the path of the reversing tractor.

### SUMMARY

The technology disclosed herein relates to devices, apparatuses, and systems for planting seeds and methods for operating the same. In particular, the technology disclosed herein relates to a seed planting apparatus that may be operated and maneuvered by a single operator. The seed planting apparatus disclosed herein may be combined with a farming vehicle, such as a two-wheel tractor, resulting in a seed planting system. For example, the seed planting apparatus disclosed herein may be rigidly coupled, or substantially rigidly coupled, to a two-wheel tractor to create a seed planting system. The seed planting apparatuses and systems disclosed herein may also be adapted to spray crops (for example, with pesticides), during operation.

The technology disclosed herein addresses certain limitations associated with existing seed planting apparatuses and systems by providing a seed planting apparatus that has a slender chassis that is rigidly, or substantially rigidly, attachable to a farming vehicle, such as a two-wheel tractor.

Seed planting systems disclosed herein, including a seed planting apparatus and a two-wheel tractor, may be operated by a single operator while seated on an attached seat on the rear of the seed planting apparatus. In particular, the seed planting systems disclosed herein are configured such that a single operator can fully control the power being delivered to the attached farming vehicle, the direction of travel of the apparatus and system, the positioning of the attached frame from which seeds are delivered, and the power settings of an attached air propulsion apparatus, while the operator is seated on the seat of the seed planting apparatus.

The various embodiments disclosed herein are appropriate for use by farmers of a wide range of sizes, weights, and physical strengths, as the center of gravity position is positioned away from the front wheels of the system and toward the rear of the system (closer to the operator) when the system is in operation, leading to increased stability and safety, as this configuration will be more resist rotational torque about the front axle of an attached farming vehicle when the farming vehicle is reversed.

The apparatuses, systems, and methods disclosed herein may be used to plant rice seeds. The apparatuses and systems can also be used to generally control and provide a seed planting rate and control the dispensing of seeds so that dispensed seeds are approximately evenly spaced in latitudinal and longitudinal directions, between and within the rows in which they are planted.

Seed planting apparatuses according to the current invention include a chassis to which a number of components are arranged on and coupled to. One or more rear wheels are coupled to the rear end of the chassis, and a seat for an operator (such as a farmer) is likewise coupled to the rear end of the chassis. An air propulsion apparatus (such as, for example, a conventional “backpack sprayer”) and storage container are positioned behind the seat. The storage container may be configured to hold seeds, grains, or legumes, such as rice seeds. Both the air propulsion apparatus and storage container are detachable from the seed planting apparatus, allowing them to be put to beneficial use when the seed planting apparatus is not in operation.

Seed planting apparatuses according to the current invention also include a frame coupled to the chassis. The frame may be arranged perpendicularly relative to the chassis, and the frame may be selectively raised and lowered relative to the ground by an operator of the seed planting apparatus. In certain embodiments, the frame may be selectively raised and lowered relative to the ground by a hand lever. In other embodiments, the frame may be selectively raised and lowered relative to the ground by a foot pedal.

A plurality of hollow members, such as flexible hoses, are arranged on and coupled to the frame. These hollow members are approximately evenly spaced along the frame, and the opening of each hollow member is directed toward the ground during operation of the seed metering apparatus. The other end of each hollow member is coupled to an opening on the bottom plate of a seed metering apparatus, which may receive seed from the storage container and air propulsion apparatus.

The seed planting apparatuses and systems disclosed herein may include seed metering apparatuses such as those disclosed in International Publication No. WO/2021/155008 and U.S. Provisional Application No. 62/967,389. These seed metering apparatuses are capable of converting an unmetered stream of seed (for example, from an air propulsion apparatus conveying seed from a storage container in a single, constant stream) into a metered stream that is provided to each of a plurality of hollow members connected to the seed metering apparatus (for example, through each of a plurality of hoses or rigid tubes connected to the seed metering apparatus).

Seed planting apparatuses disclosed herein may also include a plurality of spades coupled to the frame. Each respective spade is respectively positioned below each of the plurality of hollow members. During operation of the seed planting apparatus, the frame may be selectively lowered by a user to engage the spades with the ground to create furrows in the ground during operation of the seed planting apparatuses, which may facilitate seed planting in certain conditions.

In some embodiments, the seed planting apparatus may include a pair of rear wheels coupled to opposite sides of the rear end of the chassis. The seat may be coupled to the rear end of the chassis and positioned on the chassis between the pair of rear wheels. In these versions of the seed planting apparatus, the frame may be coupled to the rear end of the chassis behind the seat. The frame may be selectively raised and lowered relative to the ground using a hand lever that is within reach of an operator of the seed planting apparatus while seated in the seat.

In other embodiments, the seed planting apparatus may include one or more castor wheels coupled to the rear end of the chassis. In these embodiments, the seat may be coupled to the rear end of the chassis and positioned directly above, or substantially directly above, the castor wheels. In these versions of the seed planting apparatus, the frame may be coupled to the chassis in front of the seat, at a point on the chassis between the seat and front edge of the chassis. The frame may be selectively raised and lowered relative to the ground using a foot pedal within reach of an operator of the seed planting apparatus while seated in the seat.

The technology disclosed herein is also directed to a seed planting system. The seed planting system includes a seed planting apparatus and a farming vehicle, such as a conventional, commercially available two-wheel tractor.

The seed planting apparatus may be rigidly coupled to the two-wheel tractor or other farming vehicle using mechanisms and structures familiar to those of skill in the art, such as bolts, a ball and socket clamp, a hitch, a chain, a strap, or a bracket.

The two-wheel tractor includes two independently powered wheels, and the respective independently powered wheels are positioned on either side of the chassis of the seed planting apparatus when the seed planting apparatus is coupled to the two-wheel tractor. The two-wheel tractor also includes two hand controls. Each wheel of the two-wheel tractor may be respectively controlled by the hand controls, which are within reach of, and capable of being actuated by, an operator of the seed planting system while the operator sits in the seat of the seed planting apparatus. The hand controls may cut the power that is supplied to each wheel. Thus, in order to propel the seed planting system forward, the operator would not actuate either hand control, thereby allowing the two-wheel tractor's motor to power both wheels of the two-wheel tractor and causing both wheels to rotate and pull the attached seed metering apparatus in the direction of travel of the two-wheel tractor.

The technology disclosed herein is also directed to a method for planting seeds in a metered fashion. A method includes placing seeds in a storage container, coupling a seed planting apparatus to a farming vehicle, operating the farming vehicle to traverse a stretch of land with the seed planting apparatus, propelling the seeds from the storage container and into a seed metering apparatus by operating an air propulsion apparatus, and dispensing the seeds through a plurality of hollow members and into the ground in a metered fashion from each of the plurality of hollow members.

The seed and air propelled into the seed metering apparatus from the air propulsion apparatus may cause a curved chute within the seed metering apparatus to rotate about a central axis, thereby propelling the seeds into one of a plurality of seed inlets, through one of a plurality of hollow members, and into the ground in a metered fashion. The method may also encompass adjusting the power of the air propulsion apparatus in order to control the velocity of air and seed within the curved chute, and may encompass adjusting the rate at which seed is fed from the storage tank into the air propulsion apparatus. For example, the seed flow and air velocity may be adjusted to achieve a desired seed output, or to adjust for terrain, weather, or other planting conditions.

The method optionally further includes creating a plurality of furrows in the ground by dragging a plurality of spades across the ground and dispensing the seeds through a plurality of hollow members and into the furrows in a metered fashion, and/or raising or lowering a plurality of spades and/or hollow members to a desired raised or lowered position, for example, depending on soil conditions, planting conditions, planting seasons, or seeding technique.

In some embodiments, a single operator performs all steps of the method, while seated on the seed planting apparatus.

### BRIEF DESCRIPTION OF THE DRAWINGS

FIG. 1 shows a perspective view of an example embodiment of a seed planting apparatus and seed planting system.

FIG. 2 shows a side view of FIG. 1 with the frame in lowered position.

FIG. 3 shows a top view of FIG. 1.

FIG. 4 shows a rear view of FIG. 1.

FIG. 5 shows a front view of FIG. 1.

FIG. 6 shows a side view of FIG. 1 with the frame in raised position.

FIG. 7 shows a perspective view of a portion of the frame shown in FIG. 1.

FIG. 8 shows a perspective view of an alternative embodiment of a seed planting apparatus and seed planting system.

FIG. 9 shows a side view of FIG. 8.

FIG. 10 shows a top view of FIG. 8.

FIG. 11 shows a rear view of FIG. 8.

FIG. 12 shows a front view of FIG. 8.

FIG. 13 shows a perspective view of a castor wheel coupled to a chassis of seed planting apparatus according to an embodiment.

FIG. 14 shows a perspective view of a chassis coupled to a two-wheel tractor with a castor wheel and turning mechanisms according to an embodiment.

FIG. 15 shows a perspective view of a chassis coupled to a two-wheel tractor with a castor wheel and turning mechanisms according to an embodiment.

FIG. 16 shows a side view of an adjustable seat according to an embodiment.

FIG. 17 shows a perspective view of a seed metering apparatus.

FIGS. 18A, 18B, and 18C respectively show a top view, front view, and side view of a curved chute of the seed metering apparatus of FIG. 17.

### DETAILED DESCRIPTION

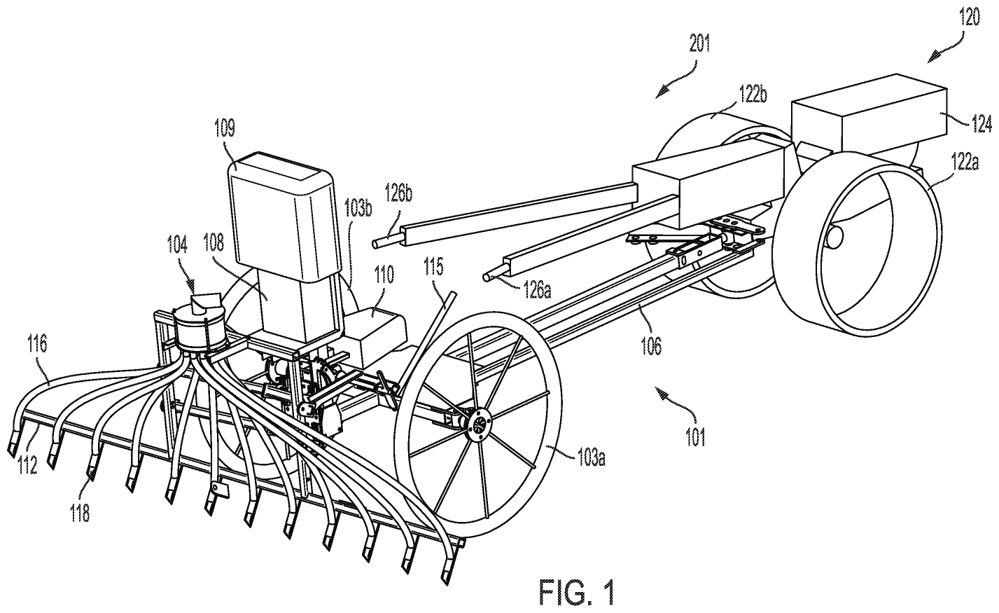

FIG. 1 shows a perspective view of a seed planting apparatus 101 and seed planting system 201. The seed planting apparatus 101 includes rear wheels, such as rear wheels 103a, 103b coupled to the rear end of the chassis 106, seed metering apparatus 104, air propulsion apparatus 108, storage container 109, seat 110, frame 112, lever 115, a plurality of hollow members 116, and a plurality of spades 118. Seed planting system 201 includes the seed planting apparatus 101 and a farming vehicle, such as the two-wheel tractor 120. The two-wheel tractor 120 includes wheels 122a, 122b, hand controls 126a, 126b, and motor casing 124.

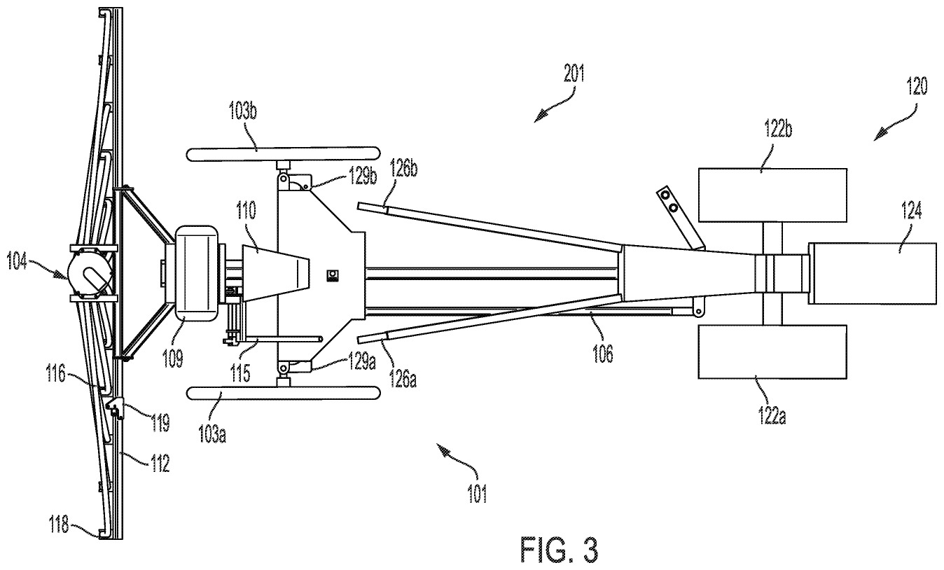

Rear wheels 103a, 103b are arranged in parallel fashion with respect to each other, with the axle of each of the rear wheels 103a, 103b respectively coupled to the chassis by pivot joints 129a, 129b (shown in FIG. 3). As used herein, the phrases “coupled to,” “connected to,” “engaged with,” or similar phrases connoting or describing a connection between one or more components, devices, and apparatuses, include both direct and indirect connections. For example, two components connected by one or more intermediary components are considered “connected” or “coupled” even when not directly in contact with each other. Alternatively, a single rear wheel (not shown) could be used.

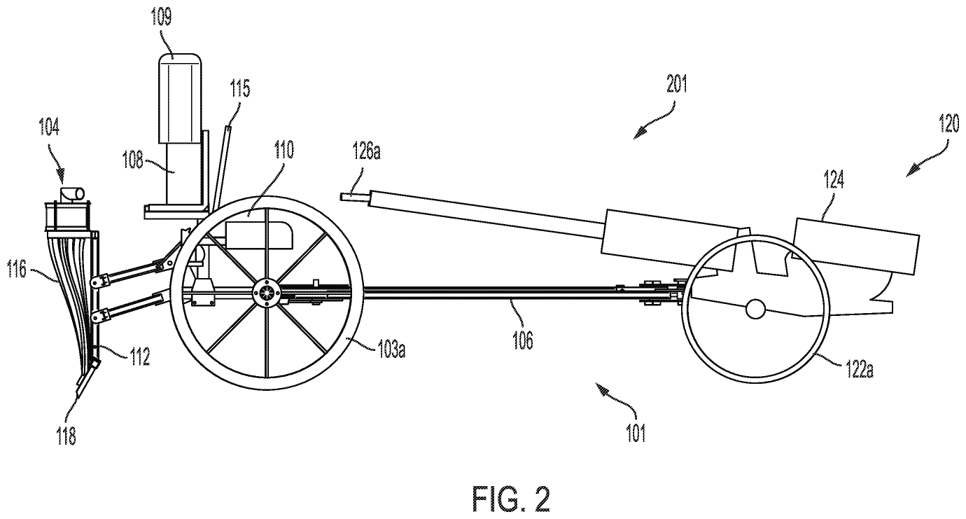

FIG. 2 shows a side view of the same seed planting apparatus 101 and seed planting system 201 depicted in FIG. 1, wherein the frame 112 is shown in a lowered position. FIG. 3 shows a top (plan) view of the same seed planting apparatus 101 and seed planting system 201 depicted in FIG. 1. Pivot joints 129a, 129b respectively permit rear wheels 103a, 103b to pivot and turn independently in the direction of travel, which enables the seed planting apparatus 101 to turn with a tight turning radius. Rear wheels 103a, 103b may be selectively constructed of one or more metals (such as iron, steel, stainless steel, or aluminum) or other materials such as PVC, bamboo, or wood. Additionally, rear wheels 103a, 103b may also include conventional tires surrounding each of the wheels, and the tires may be composed of rubber, plastic, other polymers, or blends thereof.

As shown in, for example, FIGS. 1-3, the seed planting apparatus 101 also includes a seat 110 that is coupled to the rear end of the chassis 106 and positioned between rear wheels 103a, 103b. An operator of the seed planting apparatus 101 (such as a farmer) may sit in the seat 110 during operation of the seed planting apparatus 101. The center of gravity of the apparatus 101 is positioned toward the rear of the seed planting apparatus 101 during operation, thereby providing good stability and safety at a wide range of operator weights. The seat 110 may be made of one or more metals (such as iron, steel, stainless steel, or aluminum) or other materials such as PVC, bamboo, or wood.

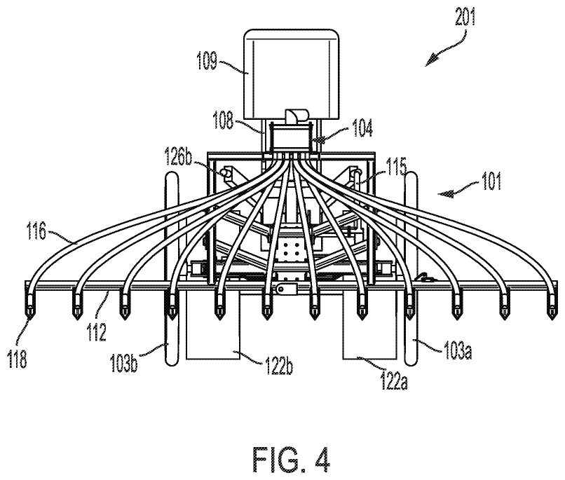

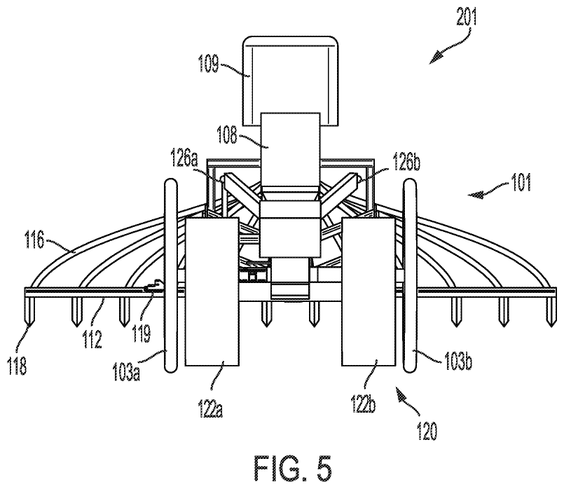

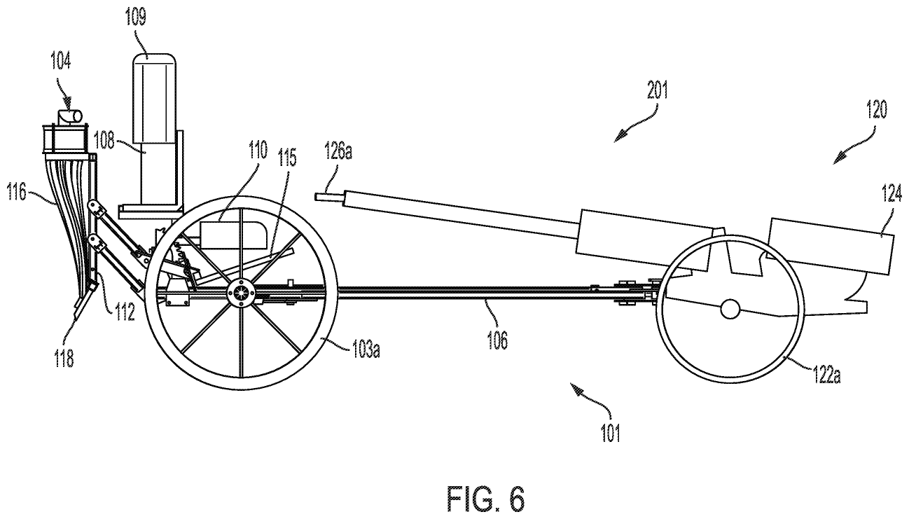

FIG. 4 and FIG. 5 respectively show a rear and front view of the seed planting apparatus 101 and seed planting system 201 depicted in FIG. 1. FIG. 6 shows a side view of FIG. 1, with the frame 112 in a raised position.

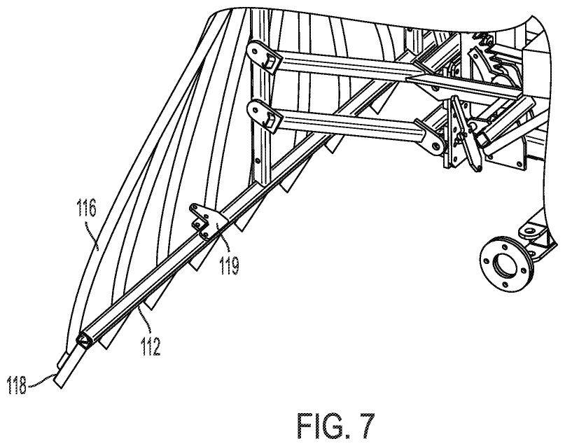

FIG. 7 shows a perspective view of a portion of the frame 112 shown in FIG. 1 As shown, the frame 112 may be folded using one or more hinges 119 on the frame 112, in order to, for example, facilitate storage of the seed planting apparatus 101. The frame 112 may also be folded in order to facilitate transport of the seed planting apparatus 101, for example, while towing, driving, hauling, or otherwise transporting the seed planting apparatus 101 from field to field or to/from a storage location. For example, folding the frame 112 may convert the frame 112 to a configuration more conducive to being towed, driven, hauled, or otherwise transported along narrow and unpaved roads.

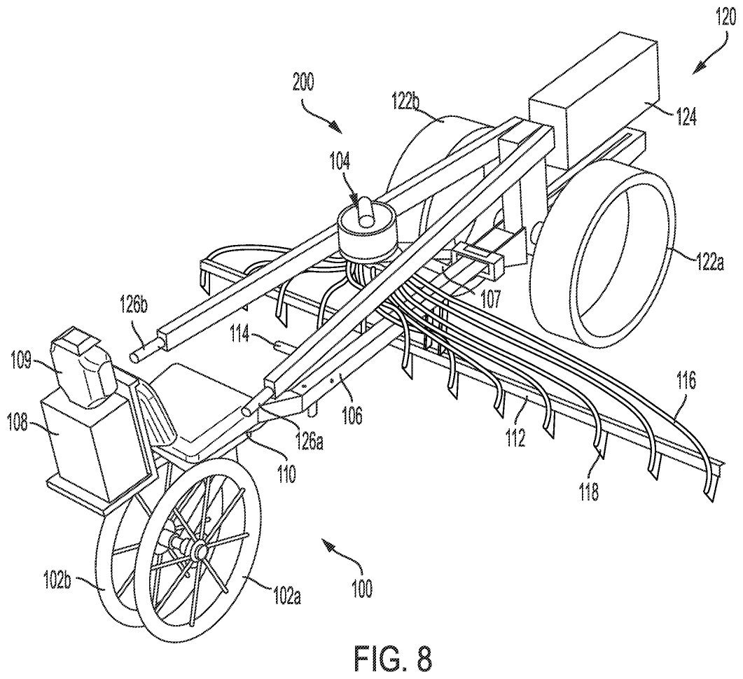

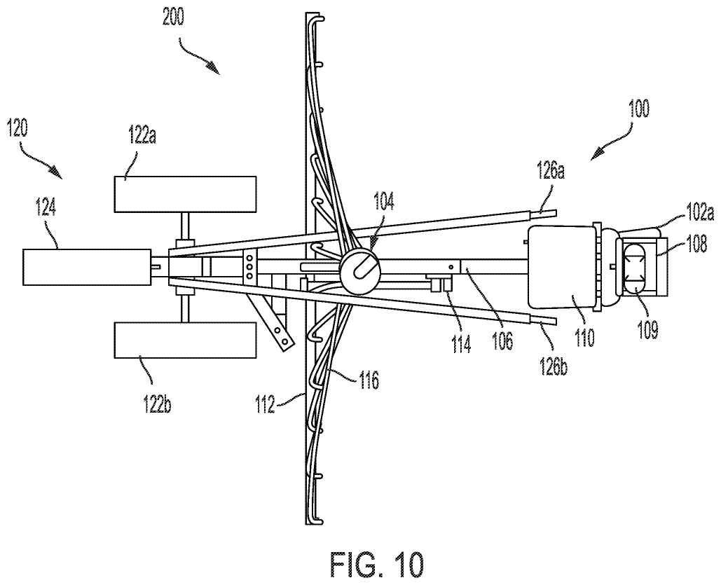

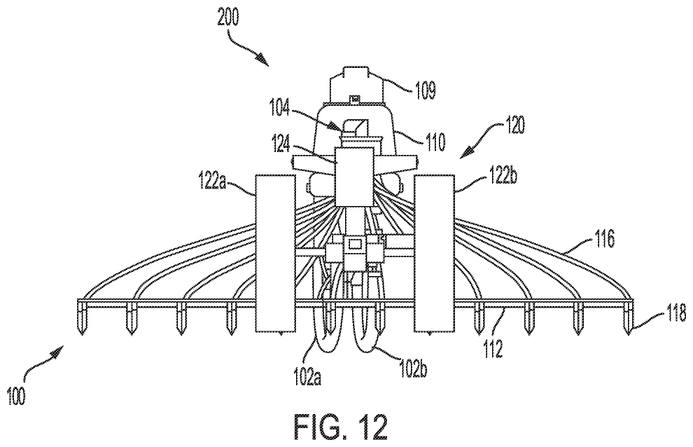

FIGS. 8-12 depict a second embodiment, showing seed planting apparatus 100 and seed planting system 200. Common reference numbers used in FIGS. 1-7 (depicting seed planting apparatus 101 and seed planting system 201) and FIGS. 8-12 (depicting seed planting apparatus 100 and seed planting system 200) denote the same structures, apparatuses, and components common to both embodiments, arranged as depicted in the respective figures and described herein.

In FIGS. 8-12, the seed planting apparatus 100 includes a chassis 106 to which various components and apparatuses are arranged on and coupled to, including castor wheels 102a, 102b, air propulsion apparatus 108, storage container 109, seat 110, frame 112, foot pedal 114, plurality of hollow members 116, and plurality of spades 118.

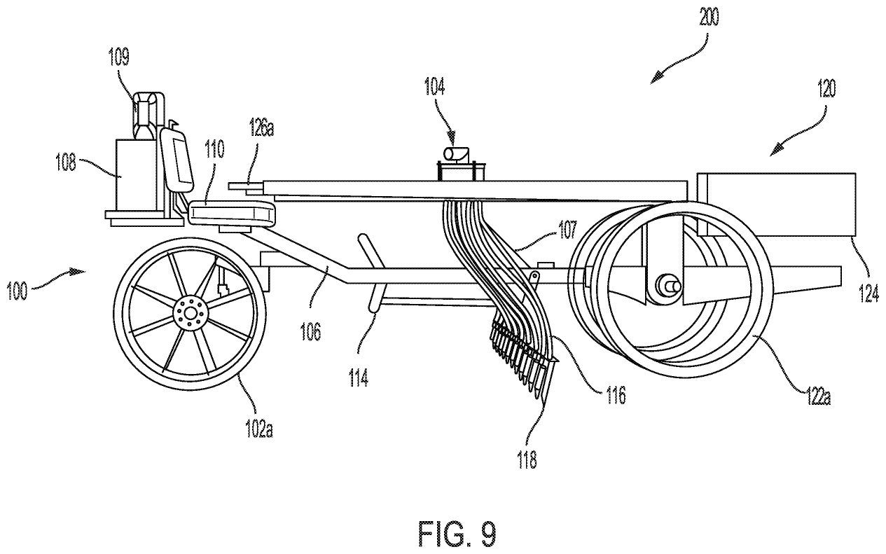

The chassis 106 of the seed planting apparatus 100 also includes a coupling bar 117 that couples a seed metering apparatus 104 to the chassis 106. As shown in FIG. 9, one end of the coupling bar 117 is coupled to the chassis 106 and the opposite end of the coupling bar 117 is coupled to the seed metering apparatus 104. The coupling bar 117 is arranged between the seed metering apparatus 104 and chassis 106 such that the seed metering apparatus 104 is positioned and secured above the chassis 106. As such, the coupling bar 117 may be coupled in a perpendicular fashion relative to the chassis 106, or as shown in FIG. 9, the coupling bar 117 may be coupled to the chassis 106 so as to form approximately a 45° inclination angle relative to the chassis 106. Those of skill in the art will appreciate that steeper and shallower inclination angles between the coupling bar 117 and chassis 106 may also be employed. The coupling bar 117 is rigid and may be constructed of, for example, one or more metals (such as iron, steel, stainless steel, or aluminum) or other materials such as PVC, bamboo, or wood.

Seed planting system 200 includes the seed planting apparatus 100 depicted in FIGS. 8-12 and a two-wheel tractor 120, such as the two-wheel tractor 120 depicted in FIGS. 1-6, and 8-12. The seed planting apparatus 100 or seed planting apparatus 101 may be rigidly, or substantially rigidly, coupled to the two-wheel tractor 120 in a conventional manner, such as by a ball and socket clamp, a hitch, a chain, a strap, a bracket, one or more nuts and bolts, and the like.

The chassis 106 of the seed planting apparatus 101 (FIGS. 1-6) or seed planting apparatus 100 (FIGS. 8-12) may be constructed of one or more metals (such as iron, steel, stainless steel, or aluminum) or other materials such as PVC, bamboo, or wood. The chassis 106 may also be coated with one or more substances that protect the chassis 106 from rust and/or degradation from ultraviolet (UV) radiation.

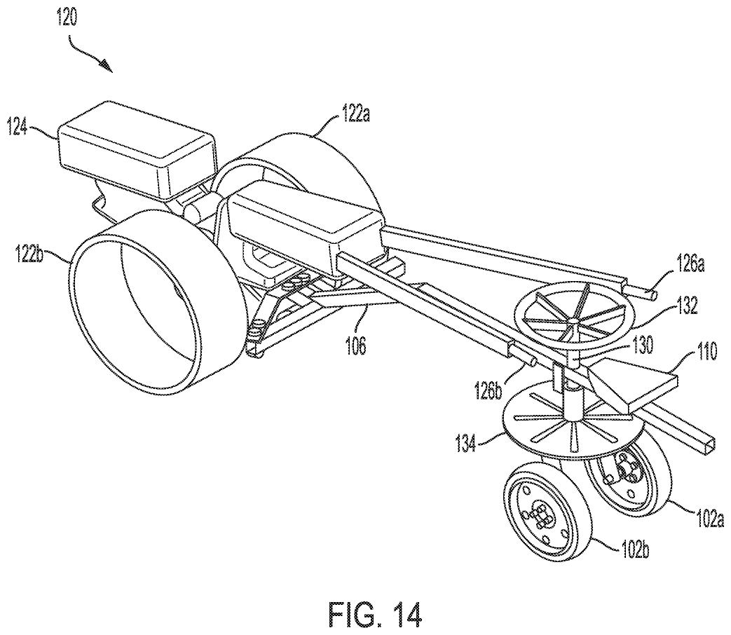

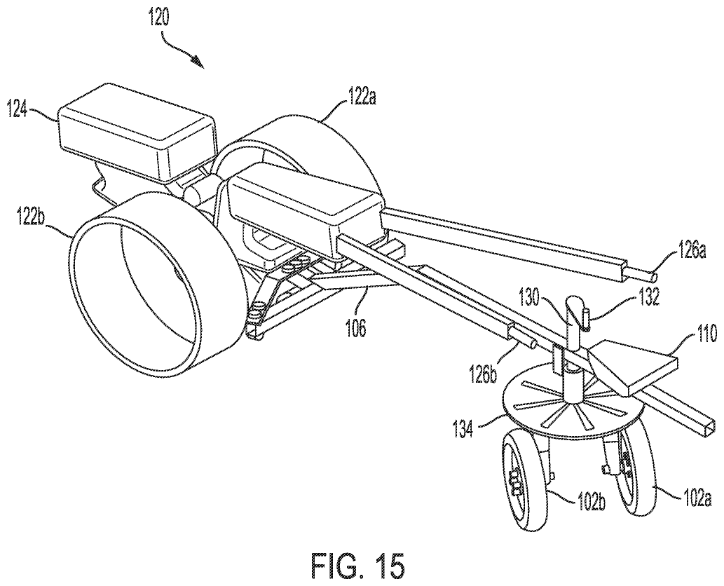

In FIGS. 8-12, the seed planting apparatus 100 includes castor wheels 102a, 102b coupled to the rear end of the chassis 106. The castor wheels 102a, 102b include two wheels arranged in a parallel fashion with respect to each other, with the two wheels connected by a single axle with shared suspension (as shown in FIGS. 8-12). The castor wheels 102a, 102b can alternatively be positioned on respective independent axles with independent suspension (as is shown in FIG. 14 and FIG. 15). Alternatively, a single castor wheel (not shown) may be utilized in lieu of the two castor wheels 102a, 102b. The castor wheels 102a, 102b may be constructed of one or more metals (such as iron, steel, stainless steel, or aluminum) or other materials such as PVC, bamboo, or wood. Additionally, the castor wheels 102a, 102b may also include tires surrounding each of the wheels, and the tires may be composed of rubber, plastic, other polymers, or blends thereof.

The castor wheels 102a, 102b can be configured to swivel about an axis and rotate in the direction of travel of the seed planting apparatus 100. In these embodiments, such as those depicted in FIG. 14 and FIG. 15, the castor wheels 102a, 102b may be connected to a vertical shaft 130 that is arranged perpendicularly to, and rotationally engaged with, the chassis 106. The castor wheels 102a, 102b may be configured to swivel about the vertical shaft 130, enabling the seed planting apparatus 100 to turn in a tight turning radius in operation. FIG. 14 and FIG. 15 depict the castor wheels 102a, 102b as two separate wheels each with an independent axle, but in other embodiments, the castor wheels 102a, 102b may be two wheels connected by a single axle, or a single wheel. Those of skill in the art will appreciate that these configurations of the castor wheels 102a, 102b may be connected to, and configured to swivel about, a vertical shaft 130, as is shown with the castor wheels 102a, 102b variation in FIG. 14 and FIG. 15.

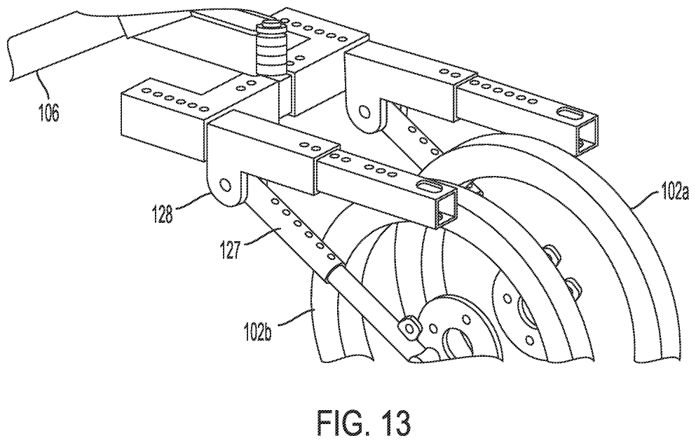

FIGS. 13-16 depict certain features of further alternative embodiments of the seed planting apparatuses and systems disclosed herein to emphasize certain aspects and attributes of those features as described herein. Common reference numbers as between the structures, apparatuses, and components depicted in FIGS. 13-16 denote the same structures and apparatuses common across embodiments, arranged as depicted in the respective figures and described herein.

In FIG. 13, the castor wheels 102a, 102b are coupled to the chassis 106 to permit the castor wheels 102a, 102b to pivot in the direction of travel of the seed planting apparatus 101, thereby permitting a tight turning radius. The castor wheels 102a, 102b can be connected by an axle (axle not shown), and respective ends of each of two rods 127 can be coupled to opposing ends of the axle. The opposite end of each rod 127 is coupled to a respective pivoting joint 128 on the rear end of the chassis 106. The pivoting joint 128 permits each rod 127, and hence the castor wheels 102a, 102b to which the rods 127 are coupled, to pivot in the direction of travel of the seed planting apparatus 100 during operation, thereby enabling a tight turning radius.

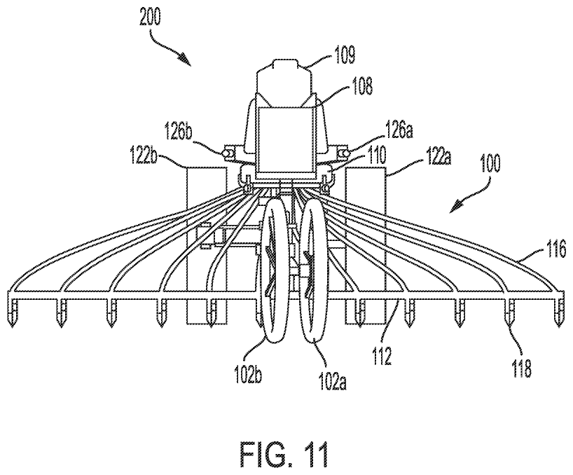

As shown in FIGS. 8-12, 14-16, the seat 110 may be coupled to the rear end of the chassis 106 and positioned directly above, or substantially directly above, castor wheels 102a, 102b (e.g., FIG. 11). As shown in FIGS. 1-6, the seat 110 may also be coupled to the rear end of the chassis 106 and positioned between rear wheels 103a, 103b. The seat 110 may optionally be cushioned. The seat 110 may also, or alternatively, include a backing, as shown in FIGS. 1-6, 8-12, such that the seat 110 is in the form of a conventional car seat, office chair, or the like. In some embodiments the seat 110 may not have a backing, as shown in FIG. 14-16.

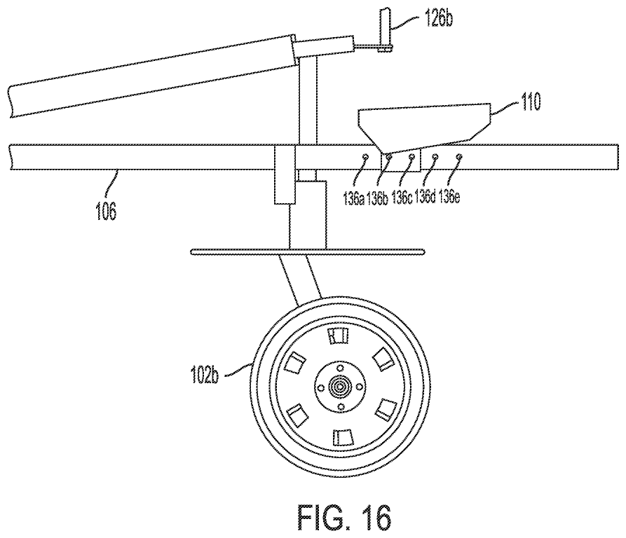

In order to accommodate operators of a variety of heights, the seat 110 may be elongated, in the manner of a bicycle seat, such that the operator can position himself or herself on the seat 110 so as to be able to reach and actuate the various controls of the seed planting apparatuses 100 and 101 and seed planting systems 200 and 201 described herein. As shown in FIG. 16, the seat 110 may be adjustable along the chassis 106, such as by sliding along the chassis 106 and locking into place at one of plurality of preset locations 136a—e.

An air propulsion apparatus 108 propels seed from a storage container 109 into the seed metering apparatus 104. The air propulsion apparatus 108 may be a conventional air propulsion apparatus utilized by farmers to disperse chemicals, fertilizers, or pesticides, which may be readily adapted to disperse seeds. These air propulsion apparatuses are commonly known in the art as “backpack sprayers,” “backpack blowers,” or “backpack misters.” For example, the air propulsion apparatus 108 may be a DM-6120, DMC-800-26, MB-580, or MB-5810 model mist blower manufactured by Yamabiko Corporation (Ohme, Tokyo, Japan). These backpack sprayers have, for example, tank capacities ranging from 20.0 L to 26.0 L, engine outputs ranging from 2.4-3.27 kW, and engine displacements of approximately 58.2 cm³. However, other commercially available backpack sprayers would likewise be suitable for use with the seed planting apparatuses 100 and 101 and seed planting systems 200 and 201 disclosed herein, such as, for example, backpack sprayers manufactured by Motoyama Indonesia (Jakarta, Indonesia). Moreover, the air propulsion apparatus 108 and storage container 109 can be detached from the seed planting apparatuses 100 and 101 to advantageously permit use for other purposes when the seed planting apparatuses 100 and 101 are not in use.

The storage container 109 may be made of plastic, steel and/or aluminum, other polymers (such as PVC), wood, or bamboo. The storage container 109 may be generally cylindrical, square, rectangular, or any other suitable shape for holding seeds, such as rice seeds, corn, mung beans, soy beans, or other types of seeds, grains, or legumes. The storage container 109 may also store chemicals or liquid solutions, such as pesticides, for spraying crops.

As shown in, for example, FIG. 6, the air propulsion apparatus 108 is attachable to the rear end of the seed planting apparatus 101, behind the seat 110 and between and behind rear wheels 103a, 103b. As shown in FIG. 8, the air propulsion apparatus 108 can also be positioned behind the back of the seat 110 and above the castor wheels 102a, 102b at the rear end of the chassis 106 of the seed planting apparatus 100.

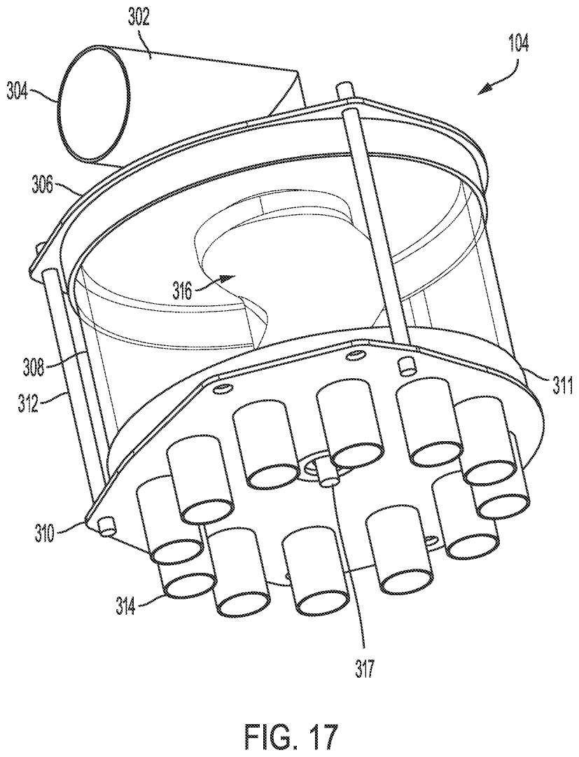

The storage container 109 may be directly connected to the air propulsion apparatus 108, and seed may be fed from the storage container 109 and into the air propulsion apparatus 108 using a lever on the air propulsion apparatus 108 that controls, for example, a conventional flow control valve with an adjustable aperture on a lower portion of the storage container 109 to allow a desired amount of seed to pass through. The air propulsion apparatus 108 may also have a separate (and independent) lever to control the power/speed of the engine of the air propulsion apparatus 108 and, thereby, for example, the velocity and/or volumetric flow rate of the air stream from the air propulsion apparatus 108 into the seed metering apparatus 104. The air propulsion apparatus 108 connects to the seed metering apparatus 104 by a tube, hose, or other suitable structure (not pictured) for conveying a steam of air and seed into the coupling joint 302 at the top of the seed metering apparatus 104 (see FIG. 17).

These two levers of the air propulsion apparatus 108 can be independently adjusted, in various combinations as desired, to respectively control the flow rate of seed from the storage container 109 into the air propulsion apparatus 108 and into the seed metering apparatus 104. As such, an operator can adjust the levers to obtain and control parameters such as the seed metering rate and total seed output. Moreover, the positioning of the air propulsion apparatus 108 in close proximity to the seat 110 in embodiments allows an operator to adjust and control these parameters while the operator is seated on the seat 110 and operating the seed planting apparatuses 100 and 101. This further facilitates operation of the seed planting apparatuses 100 and 101 by a single operator.

As shown in FIGS. 1-6, the seed metering apparatus 104 is positioned behind the seat 110, air propulsion apparatus 108, and storage container 109. The seed metering apparatus 104 is secured in position on top of the frame 112, which is coupled to the rear end of the chassis 106. The seed metering apparatus 104 is also coupled to a plurality of hollow members 116 that are coupled to the frame 112. In FIGS. 8-12, the seed metering apparatus 104 is positioned in front of the seat 110 and coupled to a plurality of hollow members 116. In FIGS. 8-12, the seed metering apparatus 104 is coupled to the chassis 106 by a coupling bar 107, as described above.

The seed metering apparatus 104 is configured to receive an unmetered stream of air and seed from the air propulsion apparatus 108 and convert that unmetered stream into a metered stream of air and seed to each of a plurality of hollow members 116 (shown as flexible hoses in, e.g., FIGS. 1-12), such that seed is directly planted into the ground in a metered fashion from each of the plurality of hollow members 116. The seed metering apparatus 104 may be a seed metering apparatus as disclosed and described in International Publication No. WO/2021/155008 and U.S. Application No. 62/967,389.

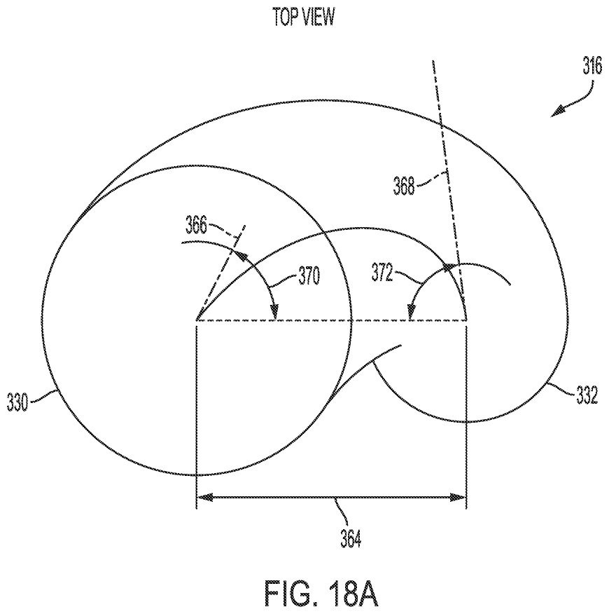

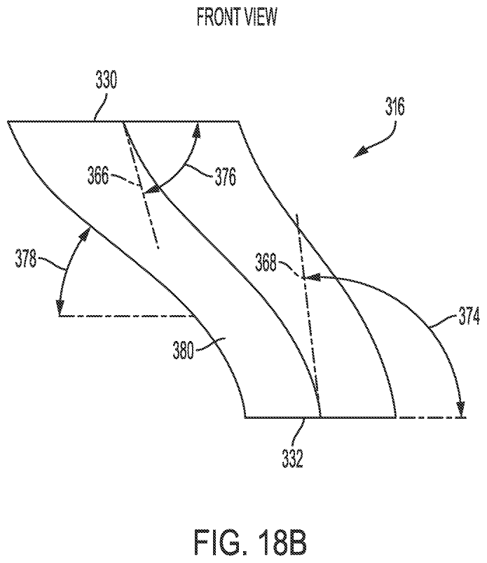

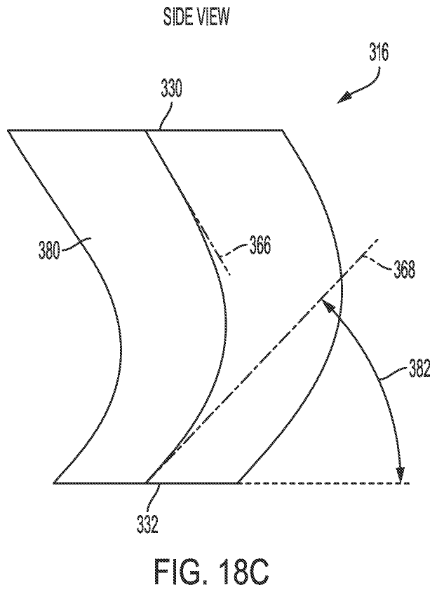

As shown in FIG. 17, the seed metering apparatus 104 includes a top plate 306, a bottom plate 310, and a drum 308 fixed between the top and bottom plates by one or more bolts 312. The top plate 306 of the seed metering apparatus 104 may include a coupling joint 302 configured to connect the seed metering apparatus 104 to the air propulsion apparatus 108 via a first circular opening 304 of the coupling joint 302. The seed metering apparatus 104 may also include a curved chute 316 contained within the drum 308, and the top opening 330 (FIGS. 18A, 18B, 18C) of the curved chute 316 may be positioned beneath the bottom opening of the coupling joint 302 on the top plate 306.

The curved chute 316 of the seed metering apparatus 104 may be configured to rotate about the center of a circular tray 311 positioned beneath the bottom opening of the curved chute 316. For example, the unmetered stream of air and seed from the air propulsion apparatus 108 may cause the curved chute 316 to rotate about a vertical shaft 317 coupled to the curved chute 316 that is received within a bearing (not shown) in the center of the circular tray 311.

The circular tray 311 of the seed metering apparatus 104 includes a plurality of seed inlets (not shown) that are configured to receive a stream of air and seed. The bottom plate 310 includes a plurality of hollow member connections 314 that are respectively positioned below each of the plurality of seed inlets on the bottom tray. Each of the plurality of hollow member connections 314 are respectively configured to engage and attach to one of a plurality of hollow members 116. Such hollow members 116 may be flexible hoses, such as those depicted in FIGS. 1-12. Such flexible hoses may be made of a flexible polymeric material, such as polyvinyl chloride (PVC) blends, rubber, or other plastics, polymers, or blends thereof. In other embodiments, the plurality of hollow members 116 may be rigid tubes made of one or more metals, wood, bamboo, or a rigid plastic.

Although any suitable number of seed inlets and hollow member connections 314 can be used, depending on factors such as agricultural conditions, type of crop being planted, planting season, weather, terrain, desired seed output, and the like, FIG. 17 shows twelve hollow member connections 314 that would correspond to twelve respective seed inlets. The twelve hollow member connections 314 are respectively coupled to twelve hollow members 116.

In operation, the seed metering apparatus 104 receives an unmetered stream of air and seed from the air propulsion apparatus 108. This unmetered stream of air and seed causes the curved chute 316 within the seed metering apparatus 104 to rotate about the center of the circular tray 311. This rotation causes the bottom opening of the curved chute 316 to be positioned over one or more seed inlets in a cyclical fashion, thereby creating a metered stream of seed through each seed inlet as seed is propelled through the curve chute 316 and into each seed inlet as the curved chute 316 rotates.

As shown in FIG. 17, the curved chute 316 continuously twists relative to a vertical axis of the chute 316. This twisting is in a convex manner relative to the top circular opening 330 (FIGS. 18A, 18B, 18C) of the curved chute 316, such that if a horizontal plane was defined as extending across the top circular opening 330, the curved chute 316 would bend away from that horizontal plane as the chute 316 helically twists down along the vertical axis of the curved chute 316. That is, the curved chute 316 is in the shape of a partial vertical helix. This shape permits the curved chute 316 to rotate in a controlled manner as the stream of air and seed from the air propulsion apparatus 108 impacts the internal surfaces of the curved internal passageway 380 of the curved chute 316. The curvature of the curved chute 316 can be better understood in reference to FIGS. 18A, 18B, and 18C, which respectively depict a top view, a front view, and a second side view of the curved chute 316.

Turning now to FIG. 18A, which shows a top view of the curved chute 316, the helical shape of the curved chute 316 can be visualized with respect to the top circular opening 330 and the bottom circular opening 332 of the curved chute 316. The curvature of the curved chute 316 may be defined by two vectors extending away from the top circular opening 330 and the bottom circular opening 332, respectively. The first vector 366 originates from the center of the top circular opening 330 and extends into the interior of the curved chute 316 in three dimensional space. That is, the first vector 366 extends horizontally in an x direction (defined as being coplanar with a horizontal plane extending across the top circular opening 330), vertically in a y direction (defined as being coplanar with the vertical axis of the curved chute 316), and also extends in a z direction that is perpendicular to both the x and y directions.

The second vector 368 originates from the center of the bottom circular opening 332 and extends upward into the interior of the curved chute 316 in three dimensional space. Like the first vector 366, the second vector 368 extends horizontally in an x direction (defined as being coplanar with a horizontal plane extending across the bottom circular opening 332), vertically in a y direction (defined as being coplanar with the vertical axis of the chute 316), and also extends in a z direction that is perpendicular to both the x and y directions. In FIG. 18A, the x-z component of the first vector 366 and the x-z component of the second vector 368 are depicted.

FIG. 18A also shows a horizontal distance 364 between the center of the top circular opening 330 and the bottom circular opening 332, as viewed from a birds-eye perspective of the curved chute 316. Additionally, as shown in FIG. 18A, a first twist angle 370 may be formed by the x-z component of the first vector 366 and the horizontal distance 364. A second twist angle 372 may be formed by the x-z component of the second vector 368 and the horizontal distance 364. The first twist angle 370 may be about 60-65° and the second twist angle 372 may be about 80-85°. This results in a total curvature of approximately 140-150° within the curved internal passageway 380 of the curved chute 316. Because the second twist angle 372 is greater than the first twist angle 370, the curvature of the curved chute 316 becomes more exaggerated toward the bottom of the curved chute 316 relative to the top of the curved chute 316. This results in a greater proportion of the seed that enters the curved chute 316 impacting an internal face of the interior of the curved chute 316 at, or substantially close to, a normal angle, thus resulting in more seed being slowed as it enters the curved chute 316. This results in a more controlled and regular flow of seed within the curved chute 316.

FIG. 18B shows a front view of the curved chute 316. In FIG. 18B, the first vector 366 and the second vector 368 extend in the same three-dimensional orientation as depicted in FIG. 18A, but in FIG. 18B, the x-y components of both the first vector 366 and the second vector 368 are depicted. The x-y component of the first vector 366 forms a declination angle 376 with a horizontal plane extending across the top circular opening 330. The declination angle 376 may be about 70-75°. The x-y component of the second vector 368 forms an inclination angle 374 with a horizontal plane extending across the bottom circular opening 332. The inclination angle 374 may be about 95-100°.

Due to the respective curvatures of the declination angle 376 and inclination angle 374, the curved chute 316 may be nearly vertically oriented (that is, nearly straight up and down), near the top and bottom of the curved chute 316, respectively. The top portion of the curved chute 316 is oriented substantially vertically in order to maintain high seed velocity as the seed enters the curved chute 316, which causes more impacts between the seed and an internal face of the interior of the curved chute 316, as described in further detail below. The bottom portion of the curved chute 316 is also oriented substantially vertically in order to increase the velocity of the seeds as they exit the curved chute 316.

Conversely, the middle portion of the curved chute 316 may have a shallower curvature in the sense that it “flattens out” and becomes more horizontal between the top and bottom portions of the curved chute 316. For example, FIG. 18B depicts a tangent angle 378, formed by a line drawn tangent to a side of the curved chute 316 when viewed from the front, and a horizontal plane bisecting the curved chute 316 as depicted in FIG. 18B. The tangent angle 378 may be approximately 35-40°, such that the interior of the curved chute 316 has a surface oriented at an angle of approximately 35-40° relative to the top circular opening 330. Thus, as seeds are propelled into the curved chute 316, a portion of the seeds will impact the 35-40° face of the interior of the chute 316 at, or substantially close to, a normal angle, thereby slowing the stream of seeds such that they are conveyed through the remaining curved internal passageway 380 of the chute 316 in a more orderly and controlled manner.

Additionally, FIG. 18B shows that the diameter of the top circular opening 330 may be greater than the diameter of the bottom circular opening 332. For example, the diameter of the top circular opening 330 may be about 70-80 mm and the diameter of the bottom circular opening 332 may be about 45-55 mm. The cross-sectional area of the curved internal passageway 380 of the curved chute 316 likewise decreases from the top circular opening 330 to the bottom circular opening 332. The relatively larger diameter of the top circular opening 330 and the top portion of the curved internal passageway 380 reduces the air and seed velocity within that section of the curved chute 316 as the combined air and seed stream enter the curved chute 316. One reason for this is to increase the ratio of chute rotation to seed output to ensure that the seed travels through the curved chute 316 such that it is fed in a controlled and metered fashion through each of the plurality of seed inlets on the circular tray 311 of the seed metering apparatus 104 as the curved chute 316 rotates. Another reason for the relatively larger diameter of the top portion of the curved internal passageway 380 is to correct any fluctuations in seed flow from the air propulsion apparatus 108. Slowing down the seed in the top portion of the curved chute 316 results in a more even and controlled seed flow rate within the curved chute 316 itself.

The curved internal passageway 380 gradually narrows to a smaller cross-sectional diameter toward the bottom circular opening 332, which will generally increase the velocity of the seed near the bottom of the curved chute 316 due to the decreased cross-sectional area of the curved internal passageway 380. Seeds are propelled to each of the seed inlets on the circular tray 311 and then through each of the plurality of hollow members 116 at an increased velocity, resulting, for example, in more effective and/or deeper penetration of seeds into the ground for planting.

Turning now to FIG. 18C, showing a side view of the curved chute 316, the same first vector 366 and second vector 368 are depicted, though only the y-z components of the respective vectors are shown in FIG. 18C. The y-z component of the second vector 368 forms a z-angle 382 with the horizontal plane extending across the bottom circular opening 332. The z-angle 382, in conjunction with the first twist angle 370 and second twist angle 372 depicted in FIG. 18A, defines how the curved internal passageway 380 of the curved chute 316 twists relative to the vertical axis of the curved chute 316.

The z-angle 382 may be in the range of 35-55°, such as about 45°. The flow of the air and seed pushes the lower section of the curved chute 316 to the side, inducing a rotation. The z-angle 382 affects spinner rotation speed. Reducing the z-angle 382 results in a greater surface area of the interior of the curved internal passageway 380 being exposed to the air and seed stream, resulting in increased rotational speed of the curved chute 316. Increasing the z-angle 382 results in greater air and seed velocity within the curved chute 316 (because less air impacts the internal surfaces of the curved internal passageway 380), but decreases the rotational speed of the curved chute 316. Those of skill in the art will appreciate that a desired z-angle is a product of these countervailing considerations.

The dimensions and angular measurements provided above are provided for exemplary purposes only, and are not limited to those ranges or measurements specifically provided. Different diameters or angular measurements according to planting conditions, type of seed being used, terrain, weather, and/or other considerations can be considering when providing for an appropriate configuration of seed metering apparatus and its constituent elements.

The seed planting apparatus 101 further includes a frame 112 that is engaged with the rear edge of the chassis 106 and positioned behind the seat 110, air propulsion apparatus 108, and storage container 109, as shown in, for example, FIGS. 1-6. The frame 112 is arranged perpendicularly with respect to the chassis 106 and configured to optionally engage with the ground during operation of the seed planting apparatus 101. The frame 112 may be constructed of one or more metals (such as iron, steel, stainless steel, or aluminum) or other materials such as PVC, bamboo, or wood.

In other embodiments, the seed planting apparatus 100 includes a frame 112 that is coupled to the chassis 106 at a point between the seat 110 and the front edge of the chassis 106, as shown in, for example, FIGS. 8-12. In these embodiments, the frame 112 is arranged perpendicularly with respect to the chassis 106 and configured to optionally engage with the ground during operation of the seed planting apparatus 100. The frame 112 may be constructed of one or more metals (such as iron, steel, stainless steel, or aluminum) or other materials such as PVC, bamboo, or wood.

The plurality of hollow members 116 may be coupled to the frame 112 and may be approximately evenly spaced along the frame 112. The plurality of hollow members 116 may be flexible hoses, such as the flexible hoses depicted in FIGS. 1-12. The top opening of each of the plurality of hollow members 116 is coupled to a hollow member connection 314 protruding from the bottom plate 310 of the seed metering apparatus 104. The even spacing of the plurality of hollow members 116 along the frame 112 results in even spacing of seed across rows of planted seed, as each hollow member 116 deposits seed in a given row of planted seed. The action of the seed metering apparatus 104 results in a metered stream of seed to each hollow member 116, resulting in even and economical spacing of seed within each row of planted seed, as described in International Publication No. WO/2021/155008 and U.S. Provisional Application No. 62/967,389.

The frame 112 may further include a plurality of spades 118, such spades being coupled to the frame 112 and arranged beneath the bottom openings of each of the plurality of hollow members 116. The spades 118 may be made of one or more metals, wood, bamboo, or a rigid plastic. The spades 118 may be configured to create furrows in the ground during operation, such that the seed propelled from the plurality of hollow members 116 is deposited into such furrows. However, the seed planting apparatuses 100 and 101 may also be operated without a plurality of spades 118, or the plurality of spades 118 may be removed to accommodate various circumstances or planting conditions (for example, soil type, climate, weather, crop type, etc.).

In some embodiments, such as those shown in FIGS. 1-6, the frame 112 may position and secure the seed metering apparatus 104 above the plurality of hollow members 116 and behind the air propulsion apparatus 108 and storage container 109 on the rear end of the chassis 106.

In an example embodiment and mode of the technology disclosed herein, the frame 112 permits raising and lowering the plurality of hollow members 116 and plurality of spades 118 relative to the ground. In an example embodiment, the frame 112 is configured to be selectively raised or lowered to engage or disengage the plurality of hollow members 116 and the plurality of spades 118 with the ground. In an example embodiment, the frame 112 is configured to be selectively raised or lowered to adjust the depth at which the plurality of spades 118 creates furrows in the ground. In an example embodiment and mode of the technology disclosed herein, an operator may operate the frame 112 to raise or lower the plurality of spades 118 and/or hollow members 116 according to the soil conditions, the planting season or stage of the planting season, the seeding technique used, or the type of seed dispensed from the device.

As shown, for example, in FIGS. 1-6, the frame 112 may be selectively raised or lowered using a hand lever 115 in communication with a joint and the frame 112. In these embodiments, pushing the hand lever 115 down will cause the frame 112 to pivot about a joint connecting the hand lever 115 to the frame 112, thereby raising the frame 112 relative to the ground. FIG. 6 shows an embodiment of the seed planting apparatus 101 with the frame 112 in a fully raised position. Pulling the hand lever 115 up will cause the frame 112 to pivot in the opposite direction, thereby lowering the frame 112 relative to the ground. FIG. 2 shows an embodiment of the seed planting apparatus 101 with the frame 112 in a fully lowered position.

Moreover, in some embodiments, the frame 112 may be locked into a selectively raised or lowered position using one or more locking mechanisms within the joint that the frame 112 is coupled to. The locking mechanisms may be configured to lock the position of the hand lever 115, and hence the position of the frame 112, into position when the hand lever 115 is fully raised (FIG. 6) or fully lowered (FIG. 2), or in intermediate positions between the fully raised or fully lowered configurations.

In other embodiments, the seed planting apparatus 100 includes a foot pedal 114 (for example, as shown in FIG. 9) that is engaged with the frame 112 and configured to pivot about a point on the chassis 106. The foot pedal 114 permits an operator (such as a farmer) to selectively raise and lower the frame 112 during operation of the seed planting apparatus 100 while the operator is seated in the seat 110. The foot pedal 114 is coupled to the chassis 106 such that the foot pedal 114 may pivot about the chassis 106 in response to an operator's foot pressing the foot pedal 114. As the foot pedal 114 pivots, a horizontal bar connected to the foot pedal 114 and the frame 112 is drawn away from the frame 112, thereby causing the frame 112 to pivot about the chassis 106 and raise up relative to the ground. As the operator retracts his or her foot away from the foot pedal 114, the frame 112 may lower back to toward the ground due to its weight. The operator may selectively raise or lower the frame 112 according to the degree to which the foot pedal 114 is pressed and extended. That is, the operator may slightly raise the frame 112 by pressing the foot pedal 114 slightly, or fully raise the frame 112 by pressing the foot pedal 114 to the fullest extent of its axis of rotation.

The foot pedal 114 may be further configured to lock in place when it is pressed by an operator to the fullest extent of its axis of rotation. This in turn locks the horizontal bar in its fully retracted configuration, thereby locking the frame 112 in a fully raised configuration. The foot pedal 114 may then be unlocked by an operator pressing a bottom portion of the foot pedal 114 in order to allow the frame 112 to lower to the ground due to its weight, or in order to selectively lower the frame 112 by gradually relieving pressure on the foot pedal 114.

The two-wheel tractor 120 includes two independently powered wheels 122a, 122b positioned on either side of the chassis 106 of the seed planting apparatus 100 or seed planting apparatus 101 when the seed planting apparatus 100 or seed planting apparatus 101 is coupled to the two-wheel tractor 120. Hand controls 126a, 126b in respective communication with each of the two wheels 122a, 122b may cut the power that is supplied by the motor (not shown) in the motor casing 124 to wheels 122a, 122b. Thus, each wheel 122a, 122b receives power from the motor in the motor casing 124 when the hand control 126a, 126b in communication with each respective wheel is not actuated, and when the hand control in communication with each respective wheel 122a, 122b is actuated, that wheel does not receive power from the motor in the motor casing 124 of the two-wheel tractor 120. These hand controls 126a, 126b are accessible to an operator of the seed planting system 200 or seed planting system 201 when the operator is seated in the seat 110.

In order to power the seed planting system 200 or seed planting system 201 forward, the operator would not engage either hand control 126a, 126b, thereby allowing the motor in the motor casing 124 to supply power to both wheels 122a, 122b. This causes both wheels 122a, 122b to rotate forward and pull the attached seed metering apparatus 100 or seed metering apparatus 101 in the direction of travel of the two-wheel tractor 120.

An operator may turn the seed planting system 200 or seed planting system 201 by actuating one of the two hand controls 126a, 126b, thereby cutting power to the wheel of the two-wheel tractor 120 that is in communication with the actuated hand control and causing that wheel to decelerate. The other wheel of the two-wheel tractor 120 may continue to receive power from the motor in the motor casing 124, causing the two-wheel tractor 120 to turn in the direction of the decelerating wheel. An operator may decelerate the seed planting system 200 or seed planting system 201 by actuating both hand controls 126a, 126b, thereby cutting power to wheels 122a and 122b.

In FIGS. 1-6, the rear wheels 103a, 103b of the seed planting apparatus 101 pivot and turn in the direction of travel of the two-wheel tractor 120, thereby allowing the seed planting apparatus 101 to turn in the direction of travel of the two-wheel tractor 120.

In FIGS. 8-12, the castor wheels 102a, 102b of the seed planting apparatus 100 pivot in the direction of travel of the two-wheel tractor 120, thereby allowing the seed planting apparatus 100 to turn in the direction of travel of the two-wheel tractor 120. FIG. 13 depicts how the castor wheels 102a, 102b may be coupled to the chassis 106 to permit the turning of the seed planting apparatus 100, as described above.

The castor wheels 102a, 102b may be configured to swivel in the direction of travel of the two-wheel tractor 120 in operation, thereby allowing the seed planting apparatus 100 to turn in the direction of travel of the two-wheel tractor 120. For example, FIG. 14 and FIG. 15 depict a configuration and embodiment wherein the castor wheels 102a, 102b are coupled to a vertical shaft 130 that is arranged perpendicularly to, and rotationally engaged with, the chassis 106 so as to permit the castor wheels 102a, 102b to swivel about the vertical shaft 130, as described above.

As further shown in FIG. 14 and FIG. 15, a hand steering mechanism 132 may be rotationally engaged with the castor wheels 102a, 102b to further facilitate turning of the castor wheels 102a, 102b and seed planting apparatus 100. The hand steering mechanism 132 is coupled to a vertical shaft 130 that is arranged perpendicularly to, and rotationally engaged with, the chassis 106 and coupled to one or more axles of the castor wheels 102a, 102b. In this configuration, a horizontal rotation of the hand steering mechanism 132 would cause the vertical shaft 130 to rotate about its vertical axis in the same direction, thereby causing the castor wheels 102a, 102b to likewise rotate in the same direction as the hand steering mechanism 132. The hand steering mechanism 132 is positioned in front of the seat 110, within reach of an operator seated in the seat 110, to enable the operator to rotate the hand steering mechanism 132 in the desired direction of travel using his or her hands while seated in the seat 110. This further facilitates maneuverability of the seed planting apparatus 100 and seed planting system 200 by a single operator.

As shown in FIG. 14, the hand steering mechanism 132 may be a circular steering wheel. As shown in FIG. 15, the hand steering mechanism 132 may be a hand crank. The hand steering mechanism 132 may be made of one or more metals (such as iron, steel, stainless steel, or aluminum) or other materials such as PVC, bamboo, or wood.

Also as shown in FIG. 14 and FIG. 15, a foot steering mechanism 134 may be rotationally engaged with the castor wheels 102a, 102b to further facilitate turning of the seed planting apparatus 100. In these embodiments, the foot steering mechanism 134 is coupled to the vertical shaft 130 that is arranged perpendicularly to, and rotationally engaged with, the chassis 106 and coupled to one or more axles of the castor wheels 102a, 102b. In this configuration, a horizontal rotation of the foot steering mechanism 134 would cause the vertical shaft 130 to rotate about its vertical axis in the same direction, thereby causing the castor wheels 102a, 102b to likewise rotate in the same direction as the foot steering mechanism 134. The foot steering mechanism 134 is positioned in front of the seat 110 in a manner such that the feet of an operator seated in the seat 110 would be engaged with the foot steering mechanism 134. This further facilitates maneuverability of the seed planting apparatus 100 and seed planting system 200 by a single operator.

The foot steering mechanism may be a grooved disc, as is shown in FIG. 14 and FIG. 15. The foot steering mechanism 134 may be made of one or more metals (such as iron, steel, stainless steel, or aluminum) or other materials such as PVC, bamboo, or wood. The operator may rotate the foot steering mechanism 134 by rotating his or her feet in the desired direction of travel while the operator is seated in the seat 110.

Some embodiments may include only a hand steering mechanism 132, while other embodiments may include only a foot steering mechanism 134, and still other embodiments may include both a hand steering mechanism 132 and foot steering mechanism 134 (as is depicted in FIG. 14 and FIG. 15). Other embodiments may not include a hand steering mechanism 132 or foot steering mechanism 134, such as those depicted in FIGS. 1-6, 8-12. However, one or both of a hand steering mechanism 132 and/or foot steering mechanism 134 may be incorporated into the embodiments depicted in FIGS. 1-6, 8-12.

Unless otherwise expressly specified, all of the numerical ranges, dimensions, values, and percentages, such as those for exemplary dimensions of the embodiments described herein, may be read as if prefaced by the word “about” even though the term “about” may not expressly appear with the range, dimension, value, or percentage. In addition, when numerical ranges are set forth herein, these ranges are inclusive of the recited range end points (that is, end points may be used). Furthermore, any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

All references, patents, and publications disclosed herein are hereby incorporated by reference in their entireties, but to the extent that any patent, publication, or other disclosure material, in whole or in part, conflicts with statements or other disclosure material set forth herein, such disclosure will only be incorporated to the extent that no conflict arises between that incorporated material and the disclosure set forth herein. To the extent necessary, the disclosure explicitly set forth herein supersedes any conflicting material incorporated herein by reference.

While the systems and methods have been particularly shown and described with references to preferred embodiments thereof, in light of the present disclosure it will be understood by persons skilled in the art that various changes in form and details may be made therein without departing from the scope of the invention as encompassed by the claims.

1. A seed planting apparatus comprising:
a chassis;
one or more rear wheels coupled to a rear end of the chassis;
a seat coupled to the rear end of the chassis;
an air propulsion apparatus and a storage container positioned behind the seat, wherein the air propulsion apparatus and storage container are detachable from the seed planting apparatus;
a frame coupled to the chassis, wherein the frame is configured to be selectively raised and lowered by an operator of the seed planting apparatus;
a plurality of hollow members coupled to and approximately evenly spaced along the frame; and
a seed metering apparatus coupled to the plurality of hollow members, and in communication with the air propulsion apparatus.

2. The seed planting apparatus of claim 1, further comprising a plurality of spades coupled to the frame, wherein each of the plurality of spades is respectively positioned below each of the plurality of hollow members.

3. The seed planting apparatus of claim 1, wherein:
the seat is positioned between a pair of rear wheels coupled to the rear end of the chassis; and
the frame is coupled to the rear end of the chassis behind the seat.

4. The seed planting apparatus of claim 3, wherein the frame is configured to be selectively raised and lowered using a hand lever within reach of an operator seated in the seat.

5. The seed planting apparatus of claim 1, wherein:
the seat is positioned directly above one or more castor wheels coupled to the rear end of the chassis; and
the frame is coupled to the chassis at a location on the chassis between the seat and the front edge of the chassis.

6. The seed planting apparatus of claim 5, wherein the frame is configured to be selectively raised and lowered using a foot pedal within reach of an operator seated in the seat.

7. A seed planting system comprising:
the seed planting apparatus of claim 1, and;
a two-wheel tractor coupled to the seed planting apparatus, the two-wheel tractor comprising two independently controllable wheels, wherein each independently controllable wheel is controllable by a hand control that is within reach of an operator seated in the seat of the seed planting apparatus.

8. A method for planting seeds in a metered fashion, the method comprising:
placing seeds in a storage container;
coupling a seed planting apparatus to a farming vehicle;
operating the farming vehicle to traverse a stretch of land with the seed planting apparatus;
propelling the seeds from the storage container and into a seed metering apparatus by operating an air propulsion apparatus;
dispensing the seeds through a plurality of hollow members and into the ground in a metered fashion from each of the plurality of hollow members; and
maneuvering the farming vehicle by operating hand controls to independently power wheels of the farming vehicle, wherein the operator is seated on a seat of the seat planting apparatus during operation.

9. The method of claim 8, wherein all steps of the method are performed by a single operator.
